(19) United States
(12) Patent Application Publication
(10) Pub. No.: US 2017/0238559 A1
(43) Pub. Date: Aug. 24, 2017

(54) POWDER COMPOSITION FOR PREPARING FLOUR PASTE

(71) Applicant: ORIENTAL YEAST CO., LTD., Itabashi-ku (JP)

(72) Inventors: Seizo KOJIMA, Saitama-shi (JP); Hiroyuki NOMOTO, Itabashi-ku (JP); Hideo NAKABAYASHI, Niiza-shi (JP)

(73) Assignee: ORIENTAL YEAST CO., LTD., Itabashi-ku (JP)

(21) Appl. No.: 15/518,987

(22) PCT Filed: Oct. 14, 2014
(86) PCT No.: PCT/JP2014/077319

§ 371 Date: Apr. 13, 2017

(51) Int. Cl. A21D 10/00; A21D 2/08

(52) U.S. Cl. CPC A21D 10/005; A21D 2/08

(57) ABSTRACT

To improve the storage property, heat-resistance and temporal stability of flour paste, and decrease the costs for the transport, storage and production of the flour paste. The present invention provides a powder composition for preparing flour paste containing processed starch, unprocessed starch, whey protein and thickener at predetermined amounts.

### TECHNICAL FIELD

The present invention relates to a powder composition that serves as a base material for flour paste for use in the production of breads and confectionery products.

### BACKGROUND ART

Flour paste is cream prepared by adding sugar, fat or oil, milk, egg, water, cocoa, chocolate, coffee, fruit juice or the like to, wheat flour or starch, and forming into paste, and is used as cream for filling or topping of breads and confectionery products, or as sheet-like cream used by interfolding the cream into dough for breads and confectionery products.

Flour pastes produced from a raw material containing processed starch have been conventionally disclosed. Patent Literature 1 describes flour paste, which is produced by subjecting a raw material containing saccharide, fat or oil, and starch containing swelling-suppressing starch derived from waxy starch and swelling-suppressing starch derived from non-waxy starch to homogenization treatment, followed by heating and cooling. Patent Literature 2 describes paste-like food such as flour paste containing small-particle starch that has crosslinked and etherified or crosslinked and esterified as a raw material. Patent Literature 3 describes flour paste produced from a raw material containing a specific amount of mung bean starch and/or pea starch, unprocessed starch and processed starch at a specific ratio. Patent Literature 4 describes flour paste produced from starch raw material containing specific swelling-adjusted starch and starch that is easily thickened at a low temperature at a specific ratio. Patent Literature 5 describes paste-like food such as flour paste containing at least one selected from waxy starch, tapioca starch, sweet potato starch, potato starch, and processed starch thereof, which have not undergone swelling-suppressing treatment, and at least one selected from crosslinked starch and heat-moisture treated starch. Patent Literature 6 describes paste-like food such as flour paste containing processed cereal starch having a specific amylose content and rice starch.

Furthermore, protein is sometimes added to a raw material for flour paste. Patent Literature 7 describes filling containing milk protein, fat or oil and starch at specific amounts, which is for interfolding into bread dough. Furthermore, Patent Literature 8 describes sheet-like flour paste containing a raw material including wheat protein and soybean protein, either singly or in combination, or a combination of wheat protein and whey protein concentrate, which is for interfolding into bread dough.

On the other hand, powder cream mix which is added with water or milk, followed by stirring the mixture, to thereby instantly prepare cream is disclosed. For example, Patent Literature 9 describes cream powder mix for mille-feuille, which contains saccharide, milk solid content, powdered fat or oil, powdered egg yolk, starch and emulsifier, wherein the starch contains a combination of two kinds from pregelatinized starch having specific amylose contents derived from corn and from wheat and distarch phosphate derived from waxy corn and pregelatinized. However, this powder mix is mix for producing cream without heating, and thus any heating treatment after the production is not considered. Therefore, the mix is poor in heat-resistance, and cream produced therefrom is powdery and poor in texture.

### CITATION LIST

### Patent Literature

### Patent Literature 1: JP 2010-268751 A

### Patent Literature 2: JP 2006-042739 A

### Patent Literature 3: JP H09-154492 A

### Patent Literature 4: JP H10-084874 A

### Patent Literature 5: JP H11-018681 A

### Patent Literature 6: JP 2004-173541 A

### Patent Literature 7: JP H07-184528 A

### Patent Literature 8: JP H11-127765 A

### Patent Literature 9: JP H10-295307 A

### SUMMARY OF INVENTION

### Technical Problem

In confectionery and bakery industries, production of various kinds of breads and confectionery products is required, and similar variety is also required for flour pastes used therefor. On the other hand, conventional prepared flour pastes have a problem that they do not have keeping quality and thus are not suitable for storage under an ordinary temperature. Therefore, it has been necessary that conventional flour pastes are produced in facilities for the production of breads and confectionery products, or transported under cooling and stored under cooling. However, it requires much labor hour and costs to produce all of various kinds of flour pastes in facilities for the production of breads and confectionery products, and to individually transport the flour pastes under cooling and individually store the flour pastes under cooling. Furthermore, in conventional flour pastes, separation of oil component and generation of lumps due to heating step sometimes occur during the production therefor, and the physical properties are easily changed during the use thereof, i.e., during heating treatment such as baking in the production of breads and confectionery products, and thus it was not easy to provide breads and confectionery products having a stable quality. Furthermore, the above-mentioned conventional powder cream mix was not necessarily satisfiable in its storage stability, heat-resistance and temporal stability The present invention provides a powder composition for preparing flour paste from which flour paste that can be stored and transported at an ordinary temperature and has excellent workability and extendability, and fine texture, can be produced.

### Solution to Problem

The present inventors did intensive studies, and consequently found that a powder composition containing processed starch, unprocessed starch, whey protein and thickener at predetermined amounts is excellent in storage property and stability, can be transported and stored under an ordinary temperature, and flour paste that is excellent in workability, extendability, heat-resistance and temporal stability, and in texture can be produced by adding, water, fat or oil, saccharide, milk product, egg and the like to the flour paste and then mixing.

Therefore, the present invention provides a powder composition for preparing flour paste, including from 30 to 70% of processed starch, from 5 to 35% of unprocessed starch, from 10 to 40% of whey protein, and from 0.5 to 10% of thickener.

Furthermore, the invention provides a method for producing flour paste, including: mixing the powder composition for preparing flour paste as mentioned above with at least water, fat or oil, saccharide and milk product; and heating the mixture.

Furthermore, the invention provides use of a powder composition including from 30 to 70% of processed starch, from 5 to 35% of unprocessed starch, from 10 to 40% of whey protein, and from 0.5 to 10% of thickener for the preparation of flour paste.

### Advantageous Effects of Invention

The powder composition for preparing flour paste of the present invention is excellent in storage property and stability, and thus enables long-term transport and long-term storage at an ordinary temperature. Furthermore, the powder composition is prepared into flour paste being excellent in workability, extendability and texture by only being mixed with water, fat or oil, saccharide, milk product, egg and the like. Furthermore, by adding another material in mixing the powder composition with water, fat or oil, saccharide, milk product, egg and the like, flour pastes having various tastes and appearances can be easily produced. Therefore, according to the invention, a necessary amount of flour paste can be easily supplied when needed, and thus the costs relating to the transport, storage and production thereof can be decreased.

### DESCRIPTION OF EMBODIMENTS

Flour paste is defined by the Food Sanitation Law in Japan as a product that is prepared by adding sugar, fat or oil, powdered milk, egg, wheat flour and the like to a main raw material such as wheat flour, starch, nut or processed products thereof, cocoa, chocolate, coffee, and flesh or juice of fruit, sterilizing the mixture by heating, forming the mixture into paste, and is filled into or applied onto breads or confectionery products for eating. In the present specification, the flour paste refers to paste containing cereal powder such as wheat flour or starch-containing powder such as starch as a main raw material, which is used as filling or topping cream for breads and confectionery products, or used by interfolding into dough for bakery products. Flour paste is generally produced by adding water, saccharide, milk product, egg, taste ingredient, fat or oil, flavor and the like to cereal powder such as wheat flour or starch, and heating and stirring them to give paste. There are various tastes and flavors for the flour paste such as custard, chocolate, cheese, milk, nut, fruit and tea leaf.

The powder composition for preparing flour paste of the present invention is a composition used as a base material of flour paste. By mixing the composition of the invention with water, fat or oil, saccharide, milk product, egg and the like, flour paste can be prepared.

The composition of the invention contains processed starch, unprocessed starch, whey protein and thickener.

Examples of the processed starch contained in the composition of the invention include pregelatinized starch and crosslinked starch. Preferable examples of the crosslinked starch include distarch phosphate, etherified distarch phosphate, acetylated distarch phosphate and acetylated distarch adipate, and more preferable examples include distarch phosphate and hydroxypropylated distarch phosphate. Preferable examples of starch as the raw material of the processed starch include corn starch, waxy corn starch, rice starch, potato starch and tapioca starch, and more preferable examples include corn starch, waxy corn starch and rice starch. Further preferable examples of the processed starch contained in the composition of the invention include corn starch phosphate and etherified (for example, hydroxypropylated) corn starch phosphate. The processed starches listed above can be used by singly or in combination of two or more kinds. The content of the processed starch in the composition of the invention is preferably from 30 to 70% by mass, more preferably from 40 to 60% by mass.

Preferable examples of the unprocessed starch contained in the composition of the invention include corn starch, waxy corn starch, rice starch, potato starch and tapioca starch, and more preferable examples include corn starch. These unprocessed starches can be used singly or in a combination of two or more kinds. The content of the unprocessed starch in the composition of the invention is preferably from 5 to 35% by mass, more preferably from 7 to 25% by mass.

Examples of the thickener contained in the composition of the invention include preferably polysaccharide thickener such as gum arabic, carrageenan, carob bean gum, agar, xanthane gum, guar gum, gellan gum, tamarind seed gum and pectin, and gelatin. These thickeners may be used singly, preferably in combination of two or more kinds. The content of the thickener in the composition of the invention is preferably from 0.5 to 10% by mass, more preferably from 1 to 7% by mass.

The content of the whey protein in the composition of the invention is preferably from 10 to 40% by mass, more preferably from 15 to 35% by mass.

Furthermore, it is preferable that the composition of the invention contains dehydrated egg. Examples of the dehydrated egg include egg albumen powder, egg yolk powder, whole egg powder, and a mixture thereof, and preferably include egg albumen powder and whole egg powder. The content of the dehydrated egg in the composition of the invention is preferably from 2 to 8% by mass, more preferably from 3 to 6% by mass.

Furthermore, the powder composition of the invention may contain saccharide (for example, sugar, isomerized sugar, monosaccharide, disaccharide, oligosaccharide, sugar alcohol and other sweeteners). The content of the saccharide in the composition of the invention is preferably from 0 to 20% by mass, more preferably from 0 to 15% by mass.

Furthermore, the composition of the invention may contain various powder materials that impart color, taste and fragrance to the flour paste such as powder edible pigment, powder flavor, dietary salt, powdered milk, powdered fat or oil and powder seasoning.

Furthermore, the composition of the invention may contain conventionally-used food additive such as antioxidant, stabilizer and pH adjusting agent for improving the storage stability of the flour paste.

When the above-mentioned the powder composition for preparing flour paste of the invention is mixed with a material containing water, fat or oil, saccharide, milk product, egg and the like, flour paste can be produced. Preferably, the flour paste is produced by mixing the composition of the invention with the material containing water, fat or oil, saccharide, milk product, egg and the like, and further heating the mixture.

Of the above-mentioned materials used for the production of the flour paste, water generally used for cooking such as tap water and purified water can be used as the water. Examples of the fat or oil include edible fat or oil such as margarine, shortening and cooking oil and powdered fat or oil thereof, and a mixture thereof. Examples of the saccharide include sugar, starch syrup, liquid sugar, isomerized sugar, monosaccharide, disaccharide, oligosaccharide, sugar alcohol, other sweeteners, and a mixture thereof. Examples of the milk product include milk, goat milk, soybean milk, powdered milk, cheese, condensed milk, yogurt, processed milk product, and a mixture thereof. Examples of the egg include liquid egg and dehydrated egg of whole egg, egg yolk and egg albumen, and a mixture thereof.

In producing flour paste from the composition of the invention, materials other than the above-mentioned water, fat or oil, saccharides, milk product and egg can further be added. Examples of said materials include various materials that impart color, taste, flavor and texture to the flour paste (for example, pigment, flavor, dietary salt, seasoning, chocolate, cocoa powder, cacao mass, vegetable or fruit and a dried product, extract or juice thereof, pulverized product or extract of tea leaf, nut, chocolate chip and jelly). These materials can be used singly or in combination of two or more kinds. Furthermore, conventionally-used food additive such as preservative, antioxidant, stabilizer and pH adjusting agent (for example, sorbic acid or salts thereof, glycine, and organic acids such as citric acid or salt thereof) can also be added.

The additive amounts of the above-mentioned water, fat or oil, saccharide, milk product, egg, other material and food additive against the powder composition of the invention can be suitably adjusted depending on composition of the powder composition, and characteristics such as taste, flavor, color, viscosity and hardness that are desired for flour paste to be produced. For example, by adjusting the amounts of water, milk and saccharide to be added to the powder composition of the invention, taste, viscosity and hardness of the flour paste can be adjusted. Furthermore, where the powder composition contains, for example, saccharide, dehydrated egg and pigment, the amounts of saccharide, egg and pigment added to the composition for the preparation of paste are decreased, or the saccharide, egg and pigment are not added accordingly. Alternatively, when chocolate, cocoa or cacao mass is used, flour paste with chocolate taste (e.g. chocolate cream) can be produced; when cheese is used, flour paste with cheese taste (e.g. cheese cream) can be produced; and when whole egg or egg yolk and vanilla are used, flour paste with custard taste (e.g. custard cream) can be produced.

Accordingly, when flour paste is produced from the composition of the invention, it is sufficient to mix at least the above-mentioned water, fat or oil, saccharide and milk product with the composition, and further, mix the above-mentioned egg, other material or food additive therewith where necessary, and heat the mixture to thereby produce flour paste. At this time, temperature for the heating differs depending on the kind and type of the flour paste to be produced, and the heating is generally conducted to a product temperature of about 50° C. or more, preferably about from 60 to 130° C., more preferably from 70 to 120° C. Furthermore, a heating means conventionally used for the production of flour paste or cream can be suitably adopted.

The content of the powder composition of the invention in the mixture containing the above-mentioned composition and the above-mentioned materials containing at least water, fat or oil, saccharide and milk product is preferably from 5 to 15 by mass, more preferably from 6 to 13% by mass.

The produced flour paste can be used for the production of breads and confectionery products as well as conventional cream. For example, breads and confectionery products can be produced by filling the flour paste into, stacking the flour paste on, or applying the flour paste onto dough before baking, and then baking the dough. Alternatively, the flour paste may be filled into, stacked on, or applied onto dough for breads and confectionery products after baking. Alternatively, breads and confectionery products can be produced by forming the flour paste into a sheet-like shape, interfolding the formed flour paste into or stacking the formed flour paste on dough for breads and confectionery products, and then baking the dough.

### EXAMPLES

The present invention will further be explained below in detail with referring to Examples, but the present invention is not limited to only these Examples.

### Reference Example 1

### (Evaluation Criteria for Flour Paste)

The flour paste prepared in the following Examples was evaluated by the following criteria.

### Texture

A: Smooth and fine melt-in-the-mouth texture

B: Slightly smooth and slightly fine melt-in-the-mouth texture

C: Slightly poor in smoothness and melt-in-the-mouth texture

D: Poor in smoothness and melt-in-the-mouth texture

### Workability

A: Fine workability

B: Slightly fine workability

C: Slightly bad workability

D: Bad workability

### Extendability

A: Excellent in extendability and extending uniformly and finely

B: Slightly excellent in extendability and no crack or holes when extended

C: Slightly poor in extendability and some cracks or holes when extended

D: Poor in extendability and many cracks or holes when extended

### Heat-Resistance

A: Excellent in heat-resistance, and hardly little change in appearance before and after baking

B: Slightly fine in heat-resistance, and slightly change in appearance before and after baking

C: Slightly poor in heat-resistance, and change in appearance before and after baking

D: Poor in heat-resistance, and significantly change in appearance before and after baking

Temporal Stability [Physical Properties (Hardness of the Paste, Generation of Separation and Lumps, Decrease in Extendability) and Shape of Flour Paste after Sealed Off into Packaging Film and Stored at 20° C. for 1 Month]

A: Little change in physical properties and shape

B: Slightly change in physical properties and shape

C: Change in physical properties and shape

D: Significantly change in physical properties and shape

### Example 1

### (Production of Flour Paste)

Powder compositions for preparing flour paste were each prepared by mixing materials described in Table 1. Using the prepared powder compositions, flour pastes were prepared according to the following recipe.

| Flour paste composition | (parts by mass) |
|---|---|
| Powder composition | 7 |
| Sugar | 22 |
| Sour agent | 0.1 |
| Milk | 25 |
| Egg yolk | 2.5 |
| Starch syrup | 17 |
| Water | 18.28 |
| Shortening | 8 |
| Flavor (vanilla flavor) | 0.1 |
| Colorant | 0.02 |
| Total | 100 |

The materials other than the shortening, flavor and colorant were mixed, stirred under warming, subsequently the shortening was added, and the mixture was further warmed to a product temperature of 90° C. by double-boiling under stirring. The flavor and colorant were then added, the warming was stopped, and the mixture was further stirred to thereby produce flour paste with custard taste. The produced flour paste was packaged and sealed off into a packaging film before the product temperature reached 65° C. or less, and cooled to room temperature (about 20° C.). For the flour paste, the texture, workability, heat-resistance and temporal stability were evaluated according to the criteria of Reference Example 1. The results are shown in Table 1.

TABLE 1

| Powder | | | | | | |
|---|---|---|---|---|---|---|
| composition | | | | | | |
| Composition | Production Examples | | | | | |
| (% by mass) | 1 | 2 | 3 | 4 | 5 | 6 |
| Hydroxy- | 20 | 25 | 30 | 30 | 10 | 40 |
| propylated | | | | | | |
| distarch | | | | | | |
| phosphate | | | | | | |
| Corn starch | 20 | 25 | 30 | 25 | 10 | 40 |
| phosphate | | | | | | |
| Corn starch | 35 | 25 | 15 | 20 | 55 | 0 |
| (unprocessed) | | | | | | |
| Whey protein | 20 | 20 | 20 | 24 | 20 | 15 |
| Agar | 0.5 | 0.5 | 0.5 | 0.5 | 0.5 | 0.5 |
| Xanthane gum | 0.5 | 0.5 | 0.5 | 0.5 | 0.5 | 0.5 |
| Egg albumen | 4 | 4 | 4 | 0 | 4 | 4 |
| powder | | | | | | |
| (Total) | (100) | (100) | (100) | (100) | (100) | (100) |
| Texture | B | A | A | A | C | C |
| Workability | A | A | A | A | C | C |
| Heat-resistance | A | A | A | A | D | B |
| Temporal | A | A | A | B | D | A |
| Stability | | | | | | |

### Example 2

### (Production of Flour Pastes)

Powder compositions for preparing flour paste were prepared by mixing materials described in Table 2. Using the prepared powder compositions, flour pastes were produced according to the following recipe.

| Flour paste composition | (parts by mass) |
|---|---|
| Powder composition | 12 |
| Sugar | 28 |
| Powdered milk | 2 |
| Dietary salt | 0.1 |
| Caramel pigment | 0.1 |
| Cocoa powder | 1.5 |
| Water | 37.2 |
| Cacao mass | 9 |
| Cooking oil | 10 |
| Flavor (chocolate flavor) | 0.1 |
| Total | 100 |

The materials other than cacao mass, cooking oil and flavor were mixed, stirred under warming, subsequently cacao mass and cooking oil were added, and the mixture was further warmed to a product temperature of 90° C. by double-boiling under stirring. Flavor was then added, the warming was stopped, the mixture was further stirred, and the stirring was stopped at the time when the product temperature had reached 80° C. The mixture was wrapped with a packaging film before the temperature reached 65° C. or less, then rolled to form the mixture into a sheet-like shape, and the formed mixture was sealed off, whereby sheet-like flour paste with chocolate taste was produced. For the flour paste, workability, extendability and temporal stability were evaluated according to the criteria of Reference Example 1. The results are shown in Table 2.

TABLE 2

| Powder | | | | | | |
|---|---|---|---|---|---|---|
| composition | | | | | | |
| Composition | Production Examples | | | | | |
| (% by mass) | 7 | 8 | 9 | 10 | 11 | 12 |
| Hydroxy- | 50 | 50 | 50 | 50 | 40 | 50 |
| propylated | | | | | | |
| corn starch | | | | | | |
| phosphate | | | | | | |
| Corn starch | 10 | 10 | 15 | 10 | 10 | 10 |
| (unprocessed) | | | | | | |
| Whey protein | 0 | 5 | 15 | 20 | 35 | 20 |
| Casein | 20 | 15 | 0 | 0 | 0 | 0 |
| Agar | 4 | 4 | 4 | 4 | 4 | 0 |
| Xanthane gum | 0.5 | 0.5 | 0.5 | 0.5 | 0.5 | 0 |
| Carob | 0.5 | 0.5 | 0.5 | 0.5 | 0.5 | 4 |
| bean gum | | | | | | |
| Egg albumen | 4 | 4 | 4 | 4 | 4 | 4 |
| powder | | | | | | |
| Sugar | 11 | 11 | 11 | 11 | 6 | 11 |
| (Total) | (100) | (100) | (100) | (100) | (100) | (100) |
| Workability | B | B | A | A | B | B |
| Extendability | C | C | A | A | A | C |
| Temporal | D | C | B | A | B | D |
| Stability | | | | | | |

### Example 3

### (Production of Filling-Type Flour Pastes)

Using the powder compositions of Preparation Examples 2, 3 and 6, flour pastes were produced according to the recipe of Example 1 but according to the following steps.

The materials other than shortening, flavor and colorant were mixed, stirred under warming, subsequently shortening was added, and flavor and colorant were then added to the mixture while the mixture was further stirred. The mixture was then subjected to a heat treatment to 110° C. by using a scraped-surface heat exchanger and cooled to a product temperature of 65° C., whereby flour paste with custard taste was produced. The produced flour paste was wrapped and sealed off into a packaging film before the product temperature reached 65° C. or less, and cooled to room temperature (about 20° C.). For the flour pastes, texture, heat-resistance and temporal stability were evaluated according to the criteria of Reference Example 1. The results are shown in Table 3.

TABLE 3

| | Production | Production | Production |
|---|---|---|---|
| Powder Composition | Example 2 | Example 3 | Example 6 |
| Texture | A | A | C |
| Heat-resistance | A | A | C |
| Temporal | A | A | B |
| Stability | | | |

### Example 4

### (Production of Filling-Type Flour Pastes)

Filling-type flour pastes (creams) were produced by using the powder composition of Production Example 2 and using materials shown in the following Tables 4 to 6. The procedures are described below.

(1) Materials of A in the following table were mixed.

(2) Materials of B were separately mixed, and stirred together with the mixture obtained in (1).

(3) The mixture obtained in (2) was warmed, and when the product temperature reached 30° C., materials of C were added, and the mixture was further heated by double-boiling with stirring (the mixture became viscous when reaching about 60° C.).

(4) When the product temperature of the mixture obtained in (3) reached 90° C., the heating was continued for about 1 minute, and the heat was turned off.

(5) Materials of D were added to the mixture obtained in (4), and the mixture was stirred until the product temperature reached about 70° C.

TABLE 4
(Recipe 1: custard cream)

| | |
|---|---|
| | Content |
| Material | (parts by mass) |

| | | |
|---|---|---|
| A | Powder composition | 7 |
| | (Production Example 2) | |
| | Sugar | 22 |
| | Preservative | 0.11 |
| | (potassium sorbate) | |
| | Sour agent | 0.07 |
| | (citric acid) | |
| | Glycine | 1.5 |
| B | Milk | 25 |
| | Egg yolk | 2.5 |
| | Starch syrup | 23 |
| | Water | 13.727 |
| C | Fat or oil | 5 |
| | (shortening or cooking oil) | |
| D | Flavor | 0.073 |
| | (vanilla flavor) | |
| | Colorant (carotene pigment) | 0.02 |

| | |
|---|---|
| Total | 100 |

TABLE 5
(Recipe 2: chocolate cream)

| | |
|---|---|
| | Content |
| Material | (parts by mass) |

| | | |
|---|---|---|
| A | Powder composition | 6 |
| | (Production Example 2) | |
| | Sugar | 35 |
| | Cocoa powder | 4 |
| | Preservative | 0.11 |
| | (potassium sorbate) | |
| | Sour agent | 0.07 |
| | (citric acid) | |
| | Glycine | 1.5 |
| B | Milk | 10 |
| | Water | 28.265 |
| C | Cacao mass | 9 |
| | Fat or oil | 6 |
| | (shortening or cooking oil) | |
| D | Flavor | 0.055 |
| | (chocolate flavor) | |

| | |
|---|---|
| Total | 100 |

TABLE 6
(Recipe 3: cheese cream)

| | |
|---|---|
| | Content |
| | (parts by |
| Material | mass) |

| | | |
|---|---|---|
| A | Powder composition | 7 |
| | (Production Example 2) | |
| | Sugar | 13 |
| | Cheese powder | 3 |
| | Dietary salt | 1 |
| | Preservative | 0.11 |
| | (potassium sorbate) | |
| | Sour agent | 0.1 |
| | (citric acid) | |
| | Glycine | 1.5 |
| B | Cream cheese | 5 |
| | Starch syrup | 28 |
| | Water | 35.99 |
| C | Fat or oil (shortening) | 5 |
| D | Flavor | 0.28 |
| | (cheese flavor) | |
| | Colorant | 0.02 |
| | (carotene pigment) | |

| | |
|---|---|
| Total | 100 |

### Example 5

### (Production of Sheet-Type Flour Pastes)

Sheet-type flour pastes were produced by using the powder composition of Preparation Example 10 and using materials shown in the following Tables 7 to 9. The procedures are described below.

(1) Materials of A in the following table were mixed.

(2) Materials of B were separately mixed, and stirred together with the mixture obtained in (1).

(3) The mixture obtained in (2) was warmed, and when the product temperature reached 45° C., materials of C were added, and the mixture was further heated by double-boiling with stirring (the mixture became viscous when reaching about 60° C.).

(4) When the product temperature of the mixture obtained in (3) reached 90° C., the heating was continued for about 1 minute, and the heat was turned off.

(5) Materials of D were added to the mixture obtained in (4), and the mixture was stirred until the product temperature reached about 80° C.

(6) The mixture obtained in (5) was filled into a container, and the mixture was rolled to form into a sheet-like shape.

TABLE 7
(Recipe 4: custard sheet)

| | |
|---|---|
| | Content |
| Material | (parts by mass) |

| | | |
|---|---|---|
| A | Powder composition | 12 |
| | (Production Example 10) | |
| | Sugar | 25 |
| | Powdered milk | 2.0 |
| | Salt | 0.05 |
| | Preservative | 0.11 |
| | (potassium sorbate) | |
| | Sour agent | 0.1 |
| | (citric acid) | |
| B | Starch syrup | 10 |
| | Water | 37.435 |
| C | Fat or oil (cooking oil) | 13 |
| D | Flavor | 0.3 |
| | (vanilla flavor) | |
| | Colorant | 0.005 |
| | (carotene pigment) | |

| | |
|---|---|
| Total | 100 |

TABLE 8
(Recipe 5: butter sheet)

| | |
|---|---|
| | Content |
| Material | (parts by mass) |

| | | |
|---|---|---|
| A | Powder composition | 12 |
| | (Production Example 10) | |
| | Sugar | 22 |
| | Powdered milk | 1.0 |
| | Salt | 0.3 |
| | Preservative | 0.11 |
| | (potassium sorbate) | |
| | Sour agent | 0.1 |
| | (citric acid) | |
| B | Starch syrup | 15 |
| | Water | 35.828 |
| C | Butter | 3 |
| | Fat or oil (shortening) | 10 |
| D | Flavor | 0.66 |
| | (butter flavor) | |
| | Colorant | 0.002 |
| | (carotene pigment) | |

| | |
|---|---|
| Total | 100 |

TABLE 9
(Recipe 6: chocolate cream sheet)

| | |
|---|---|
| | Content |
| Material | (parts by mass) |

| | | |
|---|---|---|
| A | Powder composition | 12 |
| | (Production Example 10) | |
| | Sugar | 28 |
| | Powdered milk | 2.0 |
| | Salt | 0.1 |
| | Preservative | 0.11 |
| | (potassium sorbate) | |
| | Sour agent | 0.05 |
| | (citric acid) | |
| | Caramel pigment | 0.1 |
| | Cocoa powder | 1.5 |
| B | Water | 37.080 |
| C | Cacao mass | 9 |
| | Fat or oil (shortening) | 10 |
| D | Flavor | 0.06 |
| | (chocolate flavor) | |

| | |
|---|---|
| Total | 100 |

1. A powder composition, comprising from 30 to 70% of processed starch, from 5 to 35% of unprocessed starch, from 10 to 40% of whey protein, and from 0.5 to 10% of thickener.

2. The composition according to claim 1, wherein the processed starch is at least one selected from the group consisting of distarch phosphate, etherified distarch phosphate, acetylated distarch phosphate and acetylated distarch adipate.

3. The composition according to claim 1, wherein the unprocessed starch is at least one selected from the group consisting of corn starch, waxy corn starch, rice starch, potato starch and tapioca starch.

4. The composition according to claim 1, wherein the thickener is at least one selected from the group consisting of gum arabic, carrageenan, carob bean gum, agar, xanthane gum, guar gum, gellan gum, tamarind seed gum, pectin and gelatin.

5. The composition according to claim 1, further comprising from 2 to 8% by mass of dehydrated egg.

6. A method for producing flour paste, comprising:
mixing the composition according to claim 1 with water, fat or oil, saccharide and milk product; and
heating the mixture.

7. The method according to claim 6, further comprising mixing at least one material selected from the group consisting of egg, pigment, flavor, dietary salt, seasoning, chocolate, cocoa powder, cacao mass, vegetable or fruit and dried product, extract or juice thereof, pulverized product or extract of tea leaf, nut, chocolate chip and jelly with the composition.

8. The method according to claim 6, wherein the content of the powder composition for preparing flour paste in the mixture is from 5 to 15% by mass.

9. The powder composition according to claim 1, wherein the composition is suitable for the preparation of flour paste.
